(19) United States
(12) Patent Application Publication
(10) Pub. No.: US 2012/0219871 A1
(43) Pub. Date: Aug. 30, 2012

(54) FUEL CELL SYSTEM

(76) Inventors: Young-Seung NA, Yongin-si (KR); In-Seob SONG, Yongin-si (KR); Hyun KIM, Yongin-si (KR); Hye-Jung CHO, Yongin-si (KR)

(21) Appl. No.: 13/252,995

(22) Filed: Oct. 4, 2011

(30) Foreign Application Priority Data
Feb. 25, 2011 (KR) 10-2011-0017000

(51) Int. Cl. H01M 8/06

(52) U.S. Cl. 429/414; 429/416

(57) ABSTRACT

A fuel cell system including: a fuel cell stack configured to generate electrical energy by a reaction of a fuel and an oxidant; a fuel supply configured to supply the fuel to the fuel cell stack; and an oxidant supply configured to supply the oxidant to the fuel cell stack, wherein the fuel supply includes a mixer including an inflow port, the mixer alternately receiving the fuel and water through the inflow port and being configured to mix the fuel and the water to generate a diluted fuel and supply the diluted fuel to the fuel cell stack.

### CROSS-REFERENCE TO RELATED APPLICATION

This application claims priority to and the benefit of Korean Patent Application No. 10-2011-0017000, filed in the Korean Intellectual Property Office on Feb. 25, 2011, the entire content of which is incorporated herein by reference.

### BACKGROUND

1. Field

Aspects of embodiments of the present invention relate to a fuel cell system, and to a fuel supply for supplying fuel in an appropriate concentration to a fuel cell stack.

2. Description of the Related Art

A fuel cell is a device for generating electrical energy by an electrochemical reaction between a fuel (hydrocarbon fuel, pure hydrogen, or reformed gas rich in hydrogen) and an oxidant (air or pure oxygen). From among various kinds of fuel cells, the direct methanol fuel cell (DMFC) generates electricity according to a reaction with oxygen supplied to a cathode by directly supplying methanol to an anode of the fuel cell stack.

The methanol in high concentration, the fuel in the direct methanol fuel cell system, is stored in a cartridge and is transferred to a mixer by a fuel supply pump connected to the cartridge. The highly concentrated methanol is mixed with water by the mixer to be diluted into methanol in low concentration, and the diluted methanol is supplied to the anode of the fuel cell stack.

The direct methanol fuel cell system must be small and light so that it may be used as a power supply device for various electronic devices, such as portable electronic devices including a laptop computer. Therefore, studies for down-sizing the fuel cell system, reducing its weight, and increasing energy density per weight and fuel efficiency have been developed.

The above information disclosed in this Background section is only for enhancement of understanding of the background of the described technology and, therefore, it may contain information that does not form the prior art that is already known in this country to a person of ordinary skill in the art.

### SUMMARY

According to an aspect of embodiments of the present invention, a fuel cell system is compact and has high per-weight energy density and fuel efficiency.

According to one exemplary embodiment of the present invention, a fuel cell system includes: a fuel cell stack configured to generate electrical energy by a reaction of a fuel and an oxidant; a fuel supply configured to supply the fuel to the fuel cell stack; and an oxidant supply configured to supply the oxidant to the fuel cell stack.

The fuel supply may include a mixer.

In one embodiment, the mixer includes an inflow port, and the mixer alternately receives the fuel and water through the inflow port. The mixer is configured to mix the fuel and the water to generate a diluted fuel and supply the diluted fuel to the fuel cell stack.

The fuel supply may further include a concentration controller connected to the inflow port of the mixer and controlling an amount of the fuel and an amount of the water supplied to the mixer.

The fuel supply may further include a circulation pump between the concentration controller and the mixer and configured to supply the fuel and the water output by the concentration controller to the mixer.

In one embodiment, the concentration controller includes a fuel inflow port for receiving the fuel, a water inflow port for receiving the water, and a discharge port connected to the inflow port of the mixer, and the concentration controller alternately opens the fuel inflow port and the water inflow port.

The concentration controller may control a concentration of the fuel in the diluted fuel by controlling an opening time of the fuel inflow port and an opening time of the water inflow port.

The opening time of the fuel inflow port may be less than the opening time of the water inflow port.

The fuel cell system may further include a concentration sensor arranged between the mixer and the fuel cell stack, the concentration sensor being configured to sense the concentration of the fuel in the diluted fuel supplied to the fuel cell stack.

In one embodiment, the concentration controller is electrically connected to the concentration sensor, and controls at least one of the opening time of the fuel inflow port or the opening time of the water inflow port according to the concentration of the fuel sensed by the concentration sensor.

In one embodiment, the concentration controller increases the opening time of the water inflow port when the concentration of the fuel sensed by the concentration sensor is greater than a predetermined range, and it reduces the opening time of the water inflow port when the concentration of the fuel sensed by the concentration sensor is less than the predetermined range.

The fuel cell system may further include a gas/liquid separator for recovering the water and non-reacted fuel from among a mixture of gas and liquid output by the fuel cell stack.

The water inflow port may be connected to the gas/liquid separator for receiving the water and the non-reacted fuel from the gas/liquid separator.

In one embodiment, the fuel inflow port is connected to a fuel cartridge through a supply line, and the fuel cartridge is combined with the supply line in an attachable/detachable manner.

In one embodiment, the supply line includes a nozzle receiver at an end of the supply line, and the fuel cartridge includes a nozzle coupleable with the nozzle receiver for supplying the fuel.

The fuel cell system may include a deionized water cartridge including a nozzle having a same configuration as the nozzle of the fuel cartridge.

The deionized water cartridge may be coupleable with the nozzle receiver in replacement of the fuel cartridge.

In one embodiment, the fuel inflow port is connected to a fuel cartridge, and the mixer includes another inflow port connected to a deionized water cartridge for receiving deionized water through the another inflow port.

According to an aspect of embodiments of the present invention, the number of parts of the fuel supply is reduced to reduce the volume of the fuel cell system and its weight. Further, power consumption of the fuel supply is reduced to increase the per-weight energy density and fuel efficiency and stably control concentration of the fuel that is input to the fuel cell stack.

### BRIEF DESCRIPTION OF THE DRAWINGS

The accompanying drawings, together with the specification, illustrate some exemplary embodiments of the present invention, and, together with the description, serve to explain principles of the present invention.

FIG. 1 is a schematic diagram of a fuel cell system according to an exemplary embodiment of the present invention.

FIG. 2 is an exploded perspective view of a fuel cell stack of the fuel cell system of FIG. 1.

FIG. 3 is a schematic diagram of a concentration controller of a fuel cell system according to an exemplary embodiment of the present invention.

FIG. 4 is a schematic diagram of a configuration for replacing a fuel cartridge and a deionized water cartridge in a fuel cell system according to an exemplary embodiment of the present invention.

FIG. 5 is a schematic diagram of a fuel cell system according to a comparative example.

FIG. 6 is a graph showing changes of concentration of fuel when a fuel cell system according to an exemplary embodiment of the present invention is operated.

FIG. 7 is a graph showing changes of concentration of fuel when a fuel cell system according to a comparative example is operated.

FIG. 8 is a schematic diagram of a fuel cell system according to another exemplary embodiment of the present invention.

### DETAILED DESCRIPTION

The present invention will be described more fully hereinafter with reference to the accompanying drawings, in which some exemplary embodiments of the invention are shown and described by way of illustration. As those skilled in the art would realize, the described embodiments may be modified in various different ways, all without departing from the spirit or scope of the present invention. Accordingly, the drawings and description are to be regarded as illustrative in nature and not restrictive.

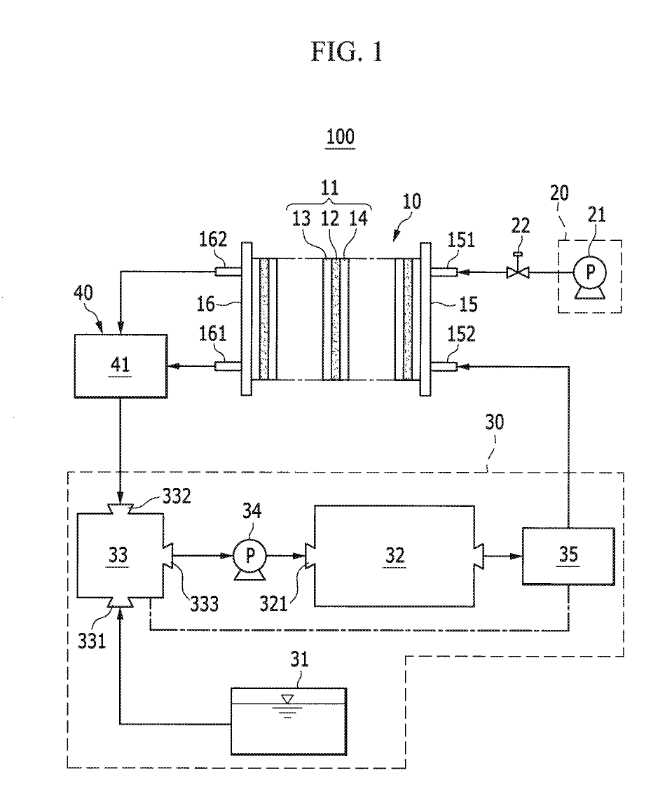

FIG. 1 is a schematic diagram of a fuel cell system according to an exemplary embodiment of the present invention.

Referring to FIG. 1, a fuel cell system 100 according to an embodiment of the present invention uses the direct methanol fuel cell (DMFC) method for generating electrical energy according to an electrochemical reaction of methanol and oxygen.

However, the present invention is not limited thereto, and the fuel cell system 100 can also be configured according to a direct oxidation fuel cell method for reacting oxygen with a liquid or gas fuel including hydrogen such as ethanol, liquefied petroleum gas (LPG), liquefied natural gas (LNG), gasoline, or butane gas.

The fuel cell system 100 includes a fuel cell stack 10 for generating electrical energy by a reaction of a fuel and an oxidant, an oxidant supply 20 for supplying an oxidant to the fuel cell stack 10, and a fuel supply 30 for supplying fuel to the fuel cell stack 10. The fuel cell system 100, in one embodiment, further includes a recovery unit 40 for recovering water and non-reacted fuel from among a mixture of a gas and a liquid output by the fuel cell stack 10 and providing the recovered water and non-reacted fuel to the fuel supply 30.

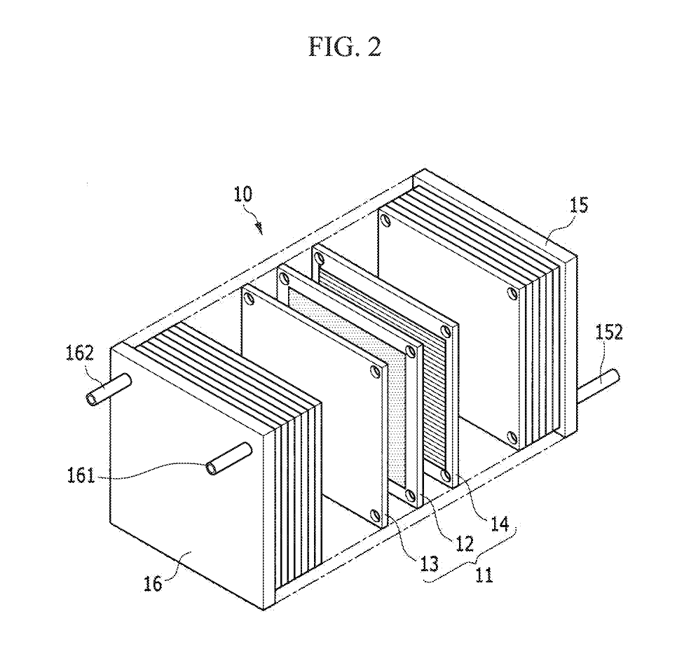

FIG. 2 is an exploded perspective view of the fuel cell stack of the fuel cell system shown in FIG. 1 according to an exemplary embodiment of the present invention.

Referring to FIGS. 1 and 2, the fuel cell stack 10 includes a plurality of electricity generators 11 for generating electrical energy by inducing an oxidation/reduction reaction between a fuel and an oxidant. Each electricity generator 11 represents a unit cell for generating electricity.

The electricity generator 11 includes a membrane electrode assembly (MEA) 12 for oxidizing and reducing the fuel and the oxidant, and separators 13 and 14 (also called bipolar plates) for supplying the fuel and the oxidant to the membrane electrode assembly 12.

The electricity generator 11 includes the pair of separators 13 and 14 with the membrane electrode assembly 12 therebetween. The membrane electrode assembly 12, in one embodiment, includes an electrolyte film disposed in a center thereof, a cathode disposed on a side of the electrolyte film, and an anode disposed on another side of the electrolyte film.

The separators 13 and 14 are closely attached to or contacting both sides of the membrane electrode assembly 12. The separator 14 attached to or contacting the anode forms a fuel route on a side facing the anode and supplies the fuel to the anode. The separator 13 attached to or contacting the cathode forms an oxidant route on a side facing the cathode and supplies the oxidant to the cathode.

At the anode, hydrogen in the fuel is decomposed into electrons and protons by the oxidation reaction of the fuel. The protons move to the cathode after passing through the electrolyte film. The electrons move to the cathode of the neighboring membrane electrode assembly passing through the separators 13 and 14, and in this instance, a current is generated because of the flow of the electrons. Moisture occurs at the cathode due to the reduction reaction of the protons and the oxygen.

In one embodiment, a pair of end plates 15 and 16 for fixing the electricity generators 11 together in a stack are disposed at outermost ends of the fuel cell stack 10. A first inlet 151 for receiving the oxidant, and a second inlet 152 for receiving the fuel may be formed on the first end plate 15. A first outlet 161 for outputting non-reacted air including moisture, and a second outlet 162 for outputting other materials such as non-reacted fuel and carbon dioxide may be formed on the second end plate 16.

Referring to FIG. 1, the oxidant supply 20 is connected to the first inlet 151 of the fuel cell stack 10 to supply the oxidant to the first inlet 151. The oxidant supply 20, in one embodiment, includes an oxidant pump 21 for supplying an oxidant, such as external air, to the fuel cell stack 10. The oxidant pump 21 may supply the oxidant with a predetermined pumping force. A control valve 22 for controlling a supply amount of the oxidant may be provided between the fuel cell stack 10 and the oxidant pump 21.

The fuel supply 30 is connected to the second inlet 152 of the fuel cell stack 10 to supply the fuel to the second inlet 152. The fuel supply 30, in one embodiment, includes a fuel cartridge 31 for storing high concentration fuel (e.g., 100% methanol), and a mixer 32 for receiving the high concentration fuel and water, mixing them, and supplying diluted low concentration fuel to the fuel cell stack 10. The fuel input to the fuel cell stack 10 may have a concentration of approximately 0.5M to 1.5M.

The fuel supply 30, in one embodiment, includes a concentration controller 33 and a circulation pump 34 between the fuel cartridge 31 and the mixer 32. The concentration controller 33 controls the concentration of the fuel input to the mixer 32 by controlling the amount of the high concentration fuel and the water supplied to the mixer 32. The circulation pump 34 supplies the high concentration fuel and the water output by the concentration controller 33 to the mixer 32 with a predetermined pumping force. A concentration sensor 35 for sensing the concentration of the fuel may be provided between the mixer 32 and the fuel cell stack 10.

The concentration controller 33 is connected to the recovery unit 40 to reuse the water output by the fuel cell stack 10. The recovery unit 40, in one embodiment, includes a gas/liquid separator 41. The gas/liquid separator 41 is connected to the first outlet 161 and the second outlet 162 of the fuel cell stack 10 to receive non-reacted oxidant including moisture from the first outlet 161 and non-reacted fuel including carbon dioxide from the second outlet 162. The gas/liquid separator 41 separates the mixture of gas and liquid into gas and liquid.

The gas/liquid separator 41 may be configured as any of various types of gas/liquid separators, such as a centrifugal separating-type or a membrane-type. The centrifugal separating-type gas/liquid separator generates centrifugal force to separate the mixture of gas and liquid into gas and liquid. In the case of the centrifugal separating-type, uniform gas and liquid separating performance can be realized irrespective of the direction of the gas/liquid separator 41. The membrane-type gas/liquid separator includes a membrane for controlling the gas to pass through to separate the mixture of gas and liquid into gas and liquid.

The gas (oxygen and carbon dioxide) separated by the gas/liquid separator 41 may be output to the outside, and the separated liquid (water and non-reacted fuel) is supplied to the concentration controller 33. The water supplied to the concentration controller 33 from the gas/liquid separator 41 may include approximately 4% to 5% of non-reacted fuel. A heat exchanger (not shown) may also be provided between the gas/liquid separator 41 and the concentration controller 33 for reducing the temperature of the water supplied to the concentration controller 33.

The concentration controller 33, in one embodiment, includes two inflow ports 331 and 332 and a discharge port 333. The inflow port 331 is a fuel inflow port 331 connected to the fuel cartridge 31 to receive high concentration fuel, and the inflow port 332 is a water inflow port 332 connected to the gas/liquid separator 41 to receive water including non-reacted fuel. The discharge port 333 is connected to an inflow port 321 of the mixer 32 through the circulation pump 34.

The concentration controller 33, in one embodiment, selectively opens the fuel inflow port 331 and the water inflow port 332 to output the fuel and the water to the discharge port 333 with a time gap therebetween. That is, the concentration controller 33 may close the water inflow port 332 and open the fuel inflow port 331 to provide the high concentration fuel of the fuel cartridge 31 to the mixer 32 for a predetermined time, and then close the fuel inflow port 331 and open the water inflow port 332 to provide the water of the gas/liquid separator 41 to the mixer 32 for a predetermined time. In one embodiment, the concentration controller 33 controls the concentration of the fuel supplied to the mixer 32 by controlling the opening and closing times of the fuel inflow port 331 and the water inflow port 332.

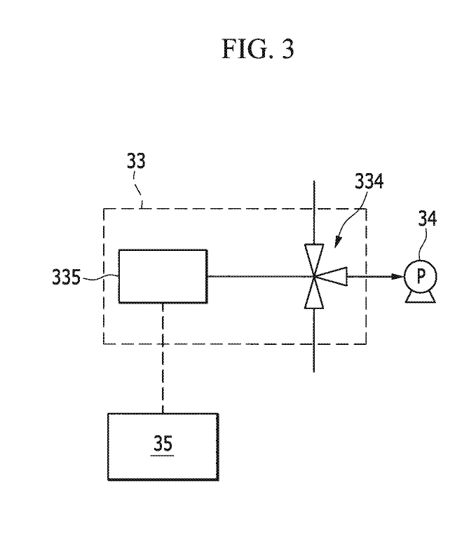

The concentration controller 33, in one embodiment, may be configured with a direction control valve and a controller for controlling the direction control valve. FIG. 3 is a schematic diagram showing the concentration controller 33 of the fuel cell system 100 shown in FIG. 1, according to an embodiment of the present invention.

Referring to FIGS. 1 and 3, the concentration controller 33, in one embodiment, includes a three-directional valve 334 as a direction control valve. A controller 335 is connected to the three-directional valve 334 to control opening, closing, and opening times of the fuel inflow port 331 and the water inflow port 332.

The three-directional valve 334 may be configured as a three-directional solenoid valve or a three-directional latch solenoid valve, for example. The three-directional solenoid valve controls opening and closing of the fuel inflow port 331 and the water inflow port 332 by using temporary power, and the three-directional latch solenoid valve changes the opening and closing of the fuel inflow port 331 and the water inflow port 332 each time power is supplied.

Referring to FIG. 1, an operation of the concentration controller 33 repeatedly performs a first stage for closing the water inflow port 332 and opening the fuel inflow port 331 to output high concentration fuel and a second stage for closing the fuel inflow port 331 and opening the water inflow port 332 to output water. The opening time of the fuel inflow port 331 in the first stage is shorter than the opening time of the water inflow port 332 in the second stage. Therefore, the fuel diluted to a low concentration, such as approximately 0.5M to 1.5M, can be supplied to the fuel cell stack 10.

In one embodiment, where approximately 100% methanol is stored in the fuel cartridge 31 and water including approximately 4% to 5% of methanol is output from the gas/liquid separator 41, the opening time of the fuel inflow port 331 in the first stage is approximately 0.3 to 0.5 seconds, and the opening time of the water inflow port 332 in the second stage is approximately 20 seconds. The opening times of the fuel inflow port 331 and the water inflow port 332 are appropriately controlled in consideration of the concentration of the fuel input to the fuel cell stack 10 and the amount of the non-reacted fuel recovered from the gas/liquid separator 41.

The mixer 32 reserves the high concentration fuel and the water provided by the concentration controller 33 with a time difference in the mixer 32 for a predetermined time to mix them, and supplies the diluted low concentration fuel to the fuel cell stack 10.

The concentration controller 33 is electrically connected to the concentration sensor 35, and controls a concentration of the fuel input to the mixer 32 by using concentration information of the fuel sensed by the concentration sensor 35. That is, in one embodiment, when the concentration sensor 35 senses a concentration that is greater than a predetermined concentration range of the fuel, the controller 335 (see FIG. 3) controls the opening time of one of the fuel inflow port 331 and the water inflow port 332 to control or adjust the concentration of the fuel.

In one embodiment, the opening time of the fuel inflow port 331 is short (e.g., approximately 0.3 to 0.5 seconds), and therefore the opening time of the fuel inflow port 331 is maintained, and the opening time of the water inflow port 332 is controlled or adjusted for greater ease of control or adjustability.

In one embodiment, when the concentration sensor 35 senses a concentration that exceeds the predetermined concentration range, the controller 335 gradually increases the opening time of the water inflow port 332 to reduce concentration of the fuel input to the fuel cell stack 10. By contrast, when the concentration sensor 35 senses a concentration that is less than the predetermined concentration range, the controller 335 gradually reduces the opening time of the water inflow port 332 to increase the concentration of the fuel input to the fuel cell stack 10.

Accordingly, the fuel cell system 100 according to embodiments of the present invention is configured to supply the fuel in a uniform or substantially uniform concentration, thereby satisfying a concentration range predetermined by the fuel cell stack 10 according to the operation of the concentration controller 33.

The fuel cartridge 31 of the fuel cell system 100 may be installed in an attachable/detachable manner, and when the fuel cartridge 31 has exhausted all of the fuel inside, the fuel cartridge 31 may be replaced with a new fuel cartridge 31. Further, when the fuel cell system 100 is maintained in an idling state for a long period of time, the mixer 32 may be dried out. In this case, deionized water must be supplied to the mixer 32. The fuel cell system 100 according to one embodiment of the present invention does not have an additional inflow port for supplying deionized water to the mixer 32 and the fuel cartridge 31 is replaceable with a deionized water cartridge.

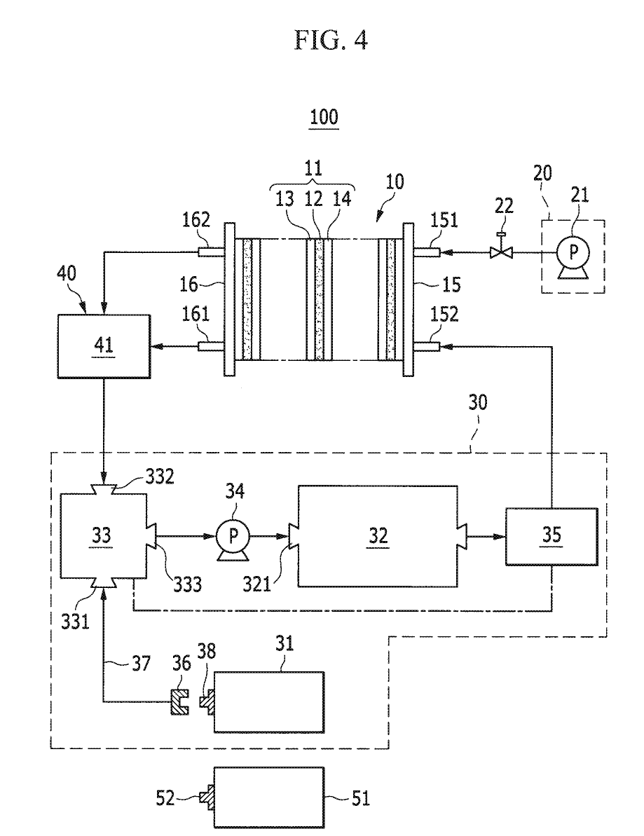

FIG. 4 is a schematic diagram of a configuration of the fuel cell system 100 according to an embodiment of the present invention in which a fuel cartridge and a deionized water cartridge are replaceable.

Referring to FIG. 4, the fuel cell system 100, in one embodiment, includes a nozzle receiver 36 connected to the concentration controller 33. The nozzle receiver 36 is formed at an end of a line 37 connected to the fuel inflow port 331 of the concentration controller 33, and the fuel cartridge 31 includes a nozzle 38 for coupling with the nozzle receiver 36 in an attachable/detachable manner. The nozzle 38 and the nozzle receiver 36 may be coupled via any conventional connecting device available for transmission of a liquid. In this instance, transmission of a liquid is single direction transmission toward the nozzle receiver 36 from the nozzle 38.

A deionized water cartridge 51, in one embodiment, includes a nozzle 52 having the same configuration as the nozzle 38 of the fuel cartridge 31. Therefore, the fuel cartridge 31 may be separated from the nozzle receiver 36, and the deionized water cartridge 51 may be combined with the nozzle receiver 36 to supply deionized water to the concentration controller 33. In an embodiment in which water is supplied to the mixer 32 by the supply of deionized water, the deionized water cartridge 51 is separated from the nozzle receiver 36 and the fuel cartridge 31 is combined with the nozzle receiver 36 to supply fuel to the concentration controller 33.

In the fuel cell system 100 according to an exemplary embodiment of the present invention, the mixer 32 has the inflow port 321 for receiving high concentration fuel and water through the inflow port 321 with a time difference. That is, in one embodiment, the mixer 32 includes the single inflow port 321 rather than including a fuel inflow port for receiving fuel and a separate water inflow port for receiving water. The existence of the single inflow port 321 allows for the single circulation pump 34 installed in the input part of the mixer 32, and such a configuration of the mixer 32 is possible as a result of the concentration controller 33.

A fuel cell system including a mixer having a plurality of inflow ports will now be described according to a comparative example, and merits of the fuel cell system 100 described above according to an exemplary embodiment of the present invention as compared to the fuel cell system according to the comparative example, and changes of concentration of the fuel measured when the actual fuel cell system is driven will be described.

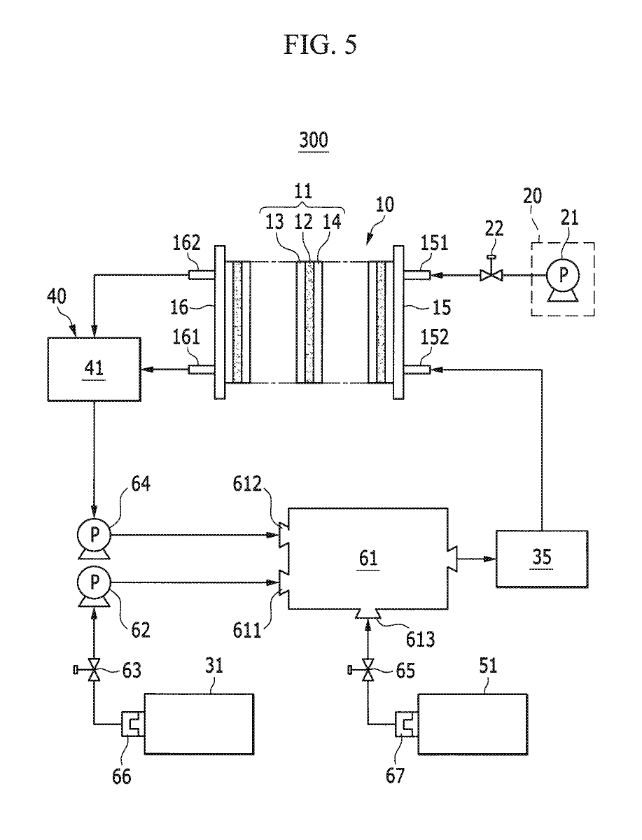

FIG. 5 is a schematic diagram of a fuel cell system according to a comparative example.

Referring to FIG. 5, in the fuel cell system 300 according to the comparative example, a mixer 61 includes a first inflow port 611 for receiving fuel, a second inflow port 612 for receiving water, and a third inflow port 613 for receiving deionized water in the dry-out condition.

In this case, a fuel supply pump 62 for supplying fuel must be provided between the fuel cartridge 31 and the first inflow port 611, and a check valve 63 operable at a high pressure to prevent a natural flow of fuel must be installed. A circulation pump 64 for supplying water must be installed between the gas/liquid separator 41 and the second inflow port 612, and a check valve 65 operable at a high pressure must be installed between the deionized water cartridge 51 and the third inflow port 613.

Also, the fuel cell system 300 according to the comparative example includes a first nozzle receiver 66 for coupling with the fuel cartridge 31, and a second nozzle receiver 67 for coupling with the deionized water cartridge 51. Same components as included in and described above with respect to the fuel cell system 100 that are also included in the fuel cell system 300 according to the comparative example shown in FIG. 5 are given the same reference numerals for ease of description. Further, repeated description of some same components and features is omitted.

Referring to FIG. 1 and FIG. 5, the fuel cell system 100 according to an exemplary embodiment of the present invention does not include the fuel supply pump 62 and the two check valves 63 and 65 and also has fewer pipes and nozzle receivers compared to the fuel cell system 300 according to the comparative example. Therefore, the fuel cell system 100 reduces the number of parts compared to the fuel cell system 300 according to the comparative example, thereby reducing the entire volume and weight.

In the fuel cell system 300 according to the comparative example, the circulation pump 64 always applies pressure to the mixer 61, so power consumption is increased, and controlling the concentration of the fuel becomes unstable when the fuel supply pump 62 applies the pressure. Particularly, the diaphragm-type fuel supply pump 62 is self-primed when the fuel is injected for at least 0.5 seconds, and it requires a great revolutions per minute (RPM) when the initial flux is supplied.

In contrast, the fuel cell system 100 according to an exemplary embodiment of the present invention has less power consumption, increases fuel efficiency, and stably controls concentration of the fuel since it replaces the fuel supply pump with the concentration controller 33. Further, the concentration controller 33 can reduce the volume of the mixer 32 compared to the mixer 61 of the comparative example because the concentration controller 33 can optimize the opening time of the fuel inflow port 331, such as approximately 0.05 to 0.2 seconds according to one embodiment.

Therefore, the fuel cell system 100 according to an exemplary embodiment of the present invention can increase per-weight energy density, and can easily perform initial drive in the case of long-term dry-out without an additional self-priming logic since the problem of self-priming of the fuel supply pump 62 in the comparative example is not present in the fuel cell system 100.

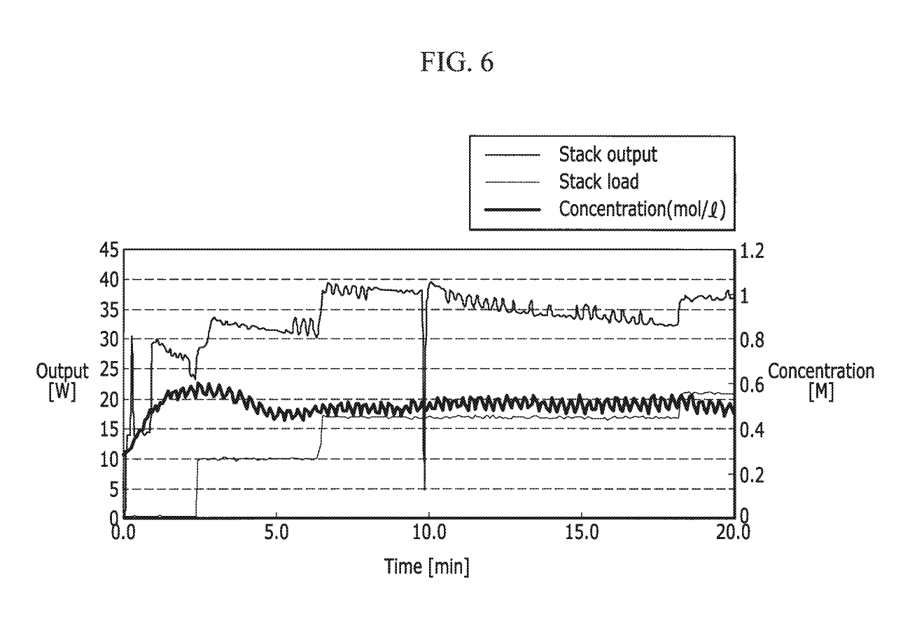

FIG. 6 is a graph showing changes of concentration of fuel when the fuel cell system 100 according to an exemplary embodiment of the present invention is operated. It is shown in FIG. 6 that a small deviation of the concentration is within 0.1M and the time for reaching the target concentration from the initial concentration is approximately 6 minutes.

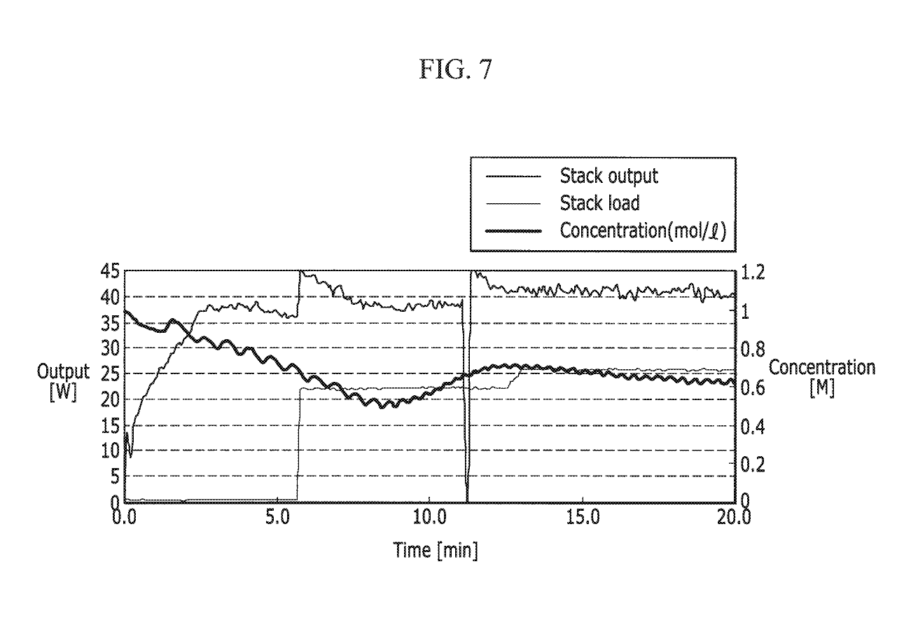

FIG. 7 is a graph showing changes of concentration of fuel when the fuel cell system 300 according to the comparative example shown in FIG. 5 is operated. It is shown in FIG. 7 that a small deviation of the concentration is within 0.1M and the time for reaching the target concentration from the initial concentration is approximately 12 minutes.

The fuel cell system 100 according to an exemplary embodiment of the present invention reduces the time for reaching the target concentration by half compared to the comparative example, which demonstrates that the concentration of the fuel is quickly stabilized after the system is driven. The fuel cell system 100 according to an exemplary embodiment of the present invention can prevent or substantially prevent the risk of fluctuation and divergence of concentration of the fuel when the capacity of the mixer 32 is reduced to half compared to the comparative example since the opening/closing change time of the fuel inflow port 331 and the water inflow port 332 of the concentration controller 33 is short.

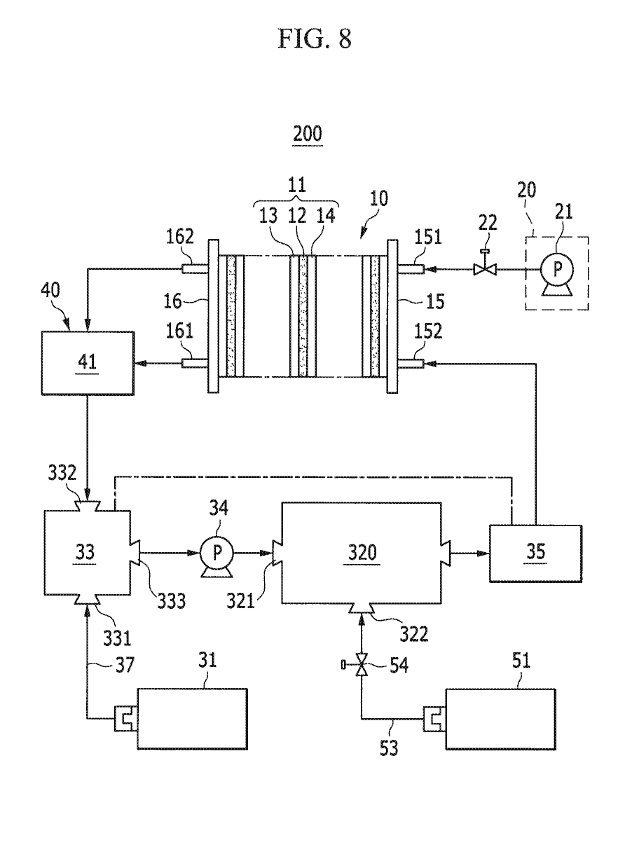

FIG. 8 is a schematic diagram of a fuel cell system according to another exemplary embodiment of the present invention.

Referring to FIG. 8, a fuel cell system 200 according to another exemplary embodiment of the present invention has the same configuration as the fuel cell system 100 described above except for the addition of the deionized water cartridge 51 and the addition of an inflow port 322 (i.e. a second inflow port) for a mixer 320 to receive deionized water from the deionized water cartridge 51. Same components as included in and described with respect to the fuel cell system 100 are given the same reference numerals, and repeated description of same components and features is omitted.

The mixer 320 of the fuel cell system 200 includes a first inflow port 321 connected to the concentration controller 33 to alternately receive high concentration fuel and water, and a second inflow port 322 connected to the deionized water cartridge 51 to receive deionized water under the dry-out condition. The deionized water cartridge 51, in one embodiment, is installed in the fuel cell system 200 in an attachable/detachable manner, and a check valve 54 for controlling free flow of the deionized water is installed in a pipe 53 connected between the deionized water cartridge 51 and the second inflow port 322.

While this disclosure has been described in connection with what are presently considered to be some practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A fuel cell system comprising:
a fuel cell stack configured to generate electrical energy by a reaction of a fuel and an oxidant;
a fuel supply configured to supply the fuel to the fuel cell stack; and
an oxidant supply configured to supply the oxidant to the fuel cell stack,
wherein the fuel supply comprises a mixer including an inflow port, the mixer alternately receiving the fuel and water through the inflow port and being configured to mix the fuel and the water to generate a diluted fuel and supply the diluted fuel to the fuel cell stack.

2. The fuel cell system of claim 1, wherein the fuel supply further comprises a concentration controller connected to the inflow port of the mixer and controlling an amount of the fuel and an amount of the water supplied to the mixer.

3. The fuel cell system of claim 2, wherein the fuel supply further comprises a circulation pump between the concentration controller and the mixer and configured to supply the fuel and the water output by the concentration controller to the mixer.

4. The fuel cell system of claim 2,
wherein the concentration controller comprises:
a fuel inflow port for receiving the fuel;
a water inflow port for receiving the water; and
a discharge port connected to the inflow port of the mixer, and
wherein the concentration controller alternately opens the fuel inflow port and the water inflow port.

5. The fuel cell system of claim 4, wherein the concentration controller controls a concentration of the fuel in the diluted fuel by controlling an opening time of the fuel inflow port and an opening time of the water inflow port.

6. The fuel cell system of claim 5, wherein the opening time of the fuel inflow port is less than the opening time of the water inflow port.

7. The fuel cell system of claim 5, further comprising a concentration sensor arranged between the mixer and the fuel cell stack and being configured to sense the concentration of the fuel in the diluted fuel supplied to the fuel cell stack.

8. The fuel cell system of claim 7, wherein the concentration controller is electrically connected to the concentration sensor, and controls at least one of the opening time of the fuel inflow port or the opening time of the water inflow port according to the concentration of the fuel sensed by the concentration sensor.

9. The fuel cell system of claim 8, wherein the concentration controller increases the opening time of the water inflow port when the concentration of the fuel sensed by the concentration sensor is greater than a predetermined range, and the concentration controller reduces the opening time of the water inflow port when the concentration of the fuel sensed by the concentration sensor is less than the predetermined range.

10. The fuel cell system of claim 4, further comprising:
a gas/liquid separator for recovering the water and non-reacted fuel from among a mixture of gas and liquid output by the fuel cell stack,
wherein the water inflow port is connected to the gas/liquid separator for receiving the water and the non-reacted fuel from the gas/liquid separator.

11. The fuel cell system of claim 4, wherein
the fuel inflow port is connected to a fuel cartridge through a supply line, and
the fuel cartridge is combined with the supply line in an attachable/detachable manner.

12. The fuel cell system of claim 11, wherein the supply line comprises a nozzle receiver at an end of the supply line, and the fuel cartridge includes a nozzle coupleable with the nozzle receiver for supplying the fuel.

13. The fuel cell system of claim 12, further comprising a deionized water cartridge including a nozzle having a same configuration as the nozzle of the fuel cartridge, the deionized water cartridge being coupleable with the nozzle receiver in replacement of the fuel cartridge.

14. The fuel cell system of claim 4, wherein
the fuel inflow port is connected to a fuel cartridge, and
the mixer includes another inflow port connected to a deionized water cartridge for receiving deionized water through the another inflow port.
